(19) United States
(12) Patent Application Publication
(10) Pub. No.: US 2011/0065900 A1
(43) Pub. Date: Mar. 17, 2011

(54) SEPARATION METHOD UTILIZING POLYALLYLAMINE LIGANDS

(75) Inventors: Bo-Lennart Johansson, Uppsala (SE); Ulrika Karlsson, Uppsala (SE); Jean-Luc Maloisel, Enebyberg (SE)

(73) Assignee: GE HEALTHCARE BIO-SCIENCE AB, UPPSALA (SE)

(21) Appl. No.: 12/993,152

(22) PCT Filed: May 29, 2009
(86) PCT No.: PCT/SE2009/050622

§ 371 Date: Nov. 17, 2010

(30) Foreign Application Priority Data
May 30, 2008 (SE) 08012817

(51) Int. Cl. C07K 16/46; C07K 1/18; C07K 16/00; B01D 15/36

(52) U.S. Cl. 530/387.3; 530/416; 530/344; 530/387.1; 210/198.2

(57) ABSTRACT

The present invention relates to a method for removing at least one negatively charged substance from an aqueous liquid by contacting the liquid with a separation matrix comprising a plurality of polyallylamine ligands, comprising binding said negatively charged substance to said ligands under conditions where the ionic strength of the aqueous liquid applied to the chromatography resin ≧0.25 M NaCl.

### CROSS-REFERENCE TO RELATED APPLICATIONS

This application is a filing under 35 U.S.C. §371 and claims priority to international patent application number PCT/SE2009/050622 filed May 29, 2009, published on Dec. 3, 2009 as WO 2009/145722, which claims priority to application number 0801281-7 filed in Sweden on May 30, 2008.

### FIELD OF THE INVENTION

The present invention relates to a method of separating at least one target substance, such as a protein or any other biomolecule, from an aqueous liquid. The invention also encompasses a separation matrix suitable for use in such a method, as well as a chromatography column packed with a separation matrix according to the invention.

### BACKGROUND OF THE INVENTION

Anion-exchange adsorption has been of interest in large scale processing of fermentation broths and the like. These kinds of liquids typically have a high ionic strength making them unsuitable for direct application to conventional ion-exchangers. One reason has been that conventional ion exchangers adsorb proteins and other bio-polymers only at moderate ionic strengths, for instance at 0.1 M or lower in NaCl. This has implied dilution of process liquids giving large volumes to process and heavy investments in process equipment.

U.S. Pat. No. 6,534,554 discloses a multicomponent ion exchange resin comprising dry granules, wherein each granule comprises at least one microdomain of at least one basic resin dispersed in a continuous phase of at least one acidic resin. In one of the embodiments the basic resin can be a polyallylamine.

U.S. Pat. No. 6,569,910 discloses an ion exchange resin comprising a dry, granulated polymerization product of (a) a vinyl monomer having an amino group or salt thereof, (b) one or more optional vinyl monomers, (c) a bulk crosslinking agent, and (d) a latent crosslinking agent, a surface crosslinking agent, or a mixture thereof. The monomer having an amino group is selected from the group consisting of a polyvinylamine, a polyethyleneimine, a poly(allylamine), a poly(diallylamine), a copolymer of a dialkylamino acrylate and a monomer having a primary or secondary amino functionality, a guanidine-modified polystyrene, a polyvinylguanidine, salts thereof, partial salts thereof, and mixtures thereof.

US 2004-0127648 discloses a method for the separation of DNA plasmids, using a chromatographic sorbent comprised of linear homopolymer is selected from the group consisting of poly-dimethylaminopropyl-methacrylamide, poly-diethylaminoethyl-methacrylamide, polyallylamine, polyvinylamine, polyethyleneimine, chitosan, and polylysine.

Polyallylamine coated silica gel has been disclosed (Liq. Chromatography for the separation of hydrobenzoic acids and phenols, Journal of Chromatography, 1985, 332, 15-18). However, this reference describes the use of polyallylamine as chromatography ligands for the separation of hydrobenzoic acids and phenols under conditions of low salt concentration.

WO 1990/014886 discloses a method for purification of factor VIII in the presence of 0.9 M NaCl on SEPHAROSE™ 4B beads to which a non-disclosed amount of polyallylamine had been coupled via epoxy activation. It is generally known that Factor VIII is a large protein, with molecular weight 280 kDa.

### SUMMARY OF THE INVENTION

One aspect of the present invention is to provide a method of separating substances from aqueous liquids of relatively high conductivity, such as fermentation broths wherein salt amounts remain from the fermentation process or eluate pools from previous ion exchange steps where salt has been added for elution. This can be achieved as defined in one or more of the appended claims.

A specific aspect of the invention is a method of separating substances by adsorption at high conductivity in the adsorption buffer, which method also provides a high binding capacity at said conductivities.

Another aspect of the invention is to provide a separation matrix capable of adsorbing substances at salt concentrations which are higher than suggested in the prior art. A specific aspect is to provide such a separation matrix comprising anion exchange ligands which are capable of adsorbing substances such as proteins at conductivities corresponding to salt concentrations at or above 0.25M. An additional aspect is to provide such a separation matrix which is tolerant to cleaning at high alkaline pH values.

A further aspect of the invention is to provide a chromatography column which can be used in a method wherein an aqueous liquid comprising at least one substance to be separated and presents a conductivity which corresponds to concentration of NaCl above 0.25M.

Further aspects and advantages of the invention will appear from the detailed description and examples below.

### DETAILED DESCRIPTION OF THE INVENTION

In a first aspect, the invention relates to a method for removing at least one negatively charged substance from an aqueous liquid by contacting the liquid with a separation matrix comprising a plurality of polyallylamine ligands, comprising binding said negatively charged substance to said ligands under conditions where the ionic strength of the aqueous liquid applied to the chromatography resin is ≧0.25 M NaCl. In this context, it is to be understood that the term “binding” refers to binding of negatively charged substance(s) in substantial amounts, in other words in amounts useful in industrial purification of proteins and other molecules. In other words, “binding” refers to binding capacities which are useful for industrial purification of biomolecules.

In a specific embodiment, the ligands are polymeric and include a repeating unit having the formula:

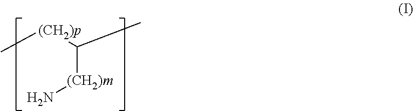

with m=0 or 1 or 2; p=1 or 2; or any salt thereof.

In an advantageous embodiment of the present method, the polymeric ligands comprise 5-3000 repeating units of the formula (I) as described above. Thus, in an advantageous embodiment, the ligands comprise 100-2000, such as 150-1000 repeating units. In one embodiment, the ligands comprise at least 1500 repeating units as described above, such as at least 2000 repeating units. In this context, it is to be understood that the polymer sizes given above will refer to an average ligand size. As the skilled person in this field will understand, it is not excluded that a small number of larger or smaller polymer ligands are present on a separation method, as some methods of polymerization may give some variation.

In one embodiment, the present invention relates to a method for removing at least one negatively charged substance from an aqueous liquid by contacting the liquid with a separation matrix comprising a plurality of ligands wherein the ligands are polymeric and have the formula:

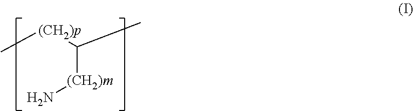

with m=0 or 1 or 2; p=1 or 2; or any salt thereof, under conditions permitting binding of said substance to said separation matrix, possibly followed by a subsequent desorption of said substance, characterized in that said separation matrix has been selected to be capable of binding said substance in a aqueous liquid at an ionic strength ≧0.25 M NaCl. The number of repeating units can be as discussed above.

In one embodiment, the substance is desorbed from the matrix by applying an aqueous liquid having a pH which is different from the pH of aqueous liquid applied to adsorb the substance in order to decrease or eliminate the net negative charge of the substance.

In another embodiment, the substance is desorbed from the matrix by applying an aqueous liquid having an ionic strength ≧0.25 M NaCl, such as in the range of 0.3-0.4 M NaCl.

The present invention enables adsorption of substances such as proteins or other biomolecules at substantially higher salt concentrations than achieved by prior art anion exchangers. More specifically, the invention enables adsorption at high levels, i.e. high binding capacity, at such increased salt concentrations. Thus, in one embodiment of the present method, the adsorbed substance is a protein adsorbed to the ligands to a level of at least 40 mg, preferably 80 mg or most advantageous of 130 mg of substance/ml separation matrix. However, as the skilled person in this field will understand, a high binding capacity will mean different values for different adsorbed substances, and consequently the capacity may vary depending on if the substance is a protein, a peptide, a nucleic acid etc.

As is well known, separation matrices such as anion exchangers are often tested with a reference or model substance, such as the model protein bovine serum albumin (BSA), and the binding capacity of an anion exchanger is commonly defined as its binding of such a model protein. As discussed above, the present inventors have shown that polyallylamine ligands are capable of a higher binding of target substance at high salt conditions than are other anion exchangers. Thus, in an advantageous embodiment of the present method, substance is adsorbed to a level corresponding to an adsorption of at least 40 mg, preferably 80 mg or most advantageous of 130 mg of BSA/ml anion-exchanger.

As indicated above, the present method is useful to separate any substance, compound or cell from an aqueous liquid. Illustrative examples that may be separated according to the invention include proteins, such as fusion proteins, antibodies, including polyclonals as well as monoclonals, antibody fragments, such as Fab fragment, and fusion proteins comprising at least part antibody, nucleic acids, such as DNA and RNA, e.g. plasmids, virus, prions, cells, including eukaryotic as well as prokaryotic cells and fragments thereof, such as cell debris, various toxic compounds such as endotoxins, organic compounds such as carbohydrates and lipids, drug candidates etc.

Thus, in a specific embodiment, the substance is a protein or a peptide. In one embodiment, the substance is an antibody; an antibody fragment or a fusion protein comprising an antibody.

In another specific embodiment, the method is useful to remove contaminants from a protein solution or virus preparation etc. by flowthrough chromatography—where the contaminants adsorb, while the target species does not bind. Illustrative examples of such protein solutions are antibodies, including polyclonals as well as monoclonals, antibody fragments, such as Fab fragments, and fusion proteins comprising at least part antibody, while examples of virus preparations are e.g. vaccine antigens and virions intended as delivery agents in nucleic acid-based therapies. One type of contaminant to remove is host cell proteins (HCP) from the cells used to express the target protein/virus. These HCP are often of a low to moderate molecular weight, such as below 100 kDa and in many cases below 50 kDa. High selectivities and capacities for HCP in the presence of salts are desirable, since the feeds often contain salts added in previous operations.

Typical liquids of high ionic strength that contain a target substances of interest are fermentation broths/liquids, for instance from the culturing of cells, and liquids derived thereof. The cells may originate from a vertebrate, such as a mammal, or an invertebrate, for instance cultured insect cells such as cells from butterflies and/or their larvae, or a microbe, e.g. cultured fungi, bacteria, yeast etc. Included are also plant cells and other kinds of living cells, preferably cultured.

The method defined above is employed in chromatographic procedures utilizing monolithic matrices or particle matrices in form of packed or fluidized beds, and also in batch-wise procedures. The purpose of the procedures may be to purify a substance carrying a negative charge, in which case the substance is bound to the matrix, and, if necessary, further purified subsequent to desorption from the matrix. Another purpose is to remove an undesired substance that carries a negative charge from a liquid. In this latter case, the liquid may be further processed after having been contacted with the matrix in the adsorption step. In both cases and if so desired, the matrix may be reused after desorption of the bound substance.

Further, the present method may be used as one step of a multi-step process for purification of a substance, such as the above-discussed biomolecules.

A second aspect of the invention relates to an anion-exchanger comprising a plurality of anion-exchange ligands each of which is attached via spacer to a base matrix, wherein each ligand is of polymeric nature and includes a repeating unit having the formula:

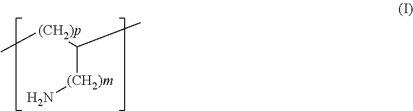

with m=0 or 1 or 2; p=1 or 2, or a salt thereof. The number of repeating units can be as discussed above.

In one embodiment, the anion-exchanger comprises a plurality of anion-exchange ligands each of which is attached via spacer to a base matrix, wherein each ligand is of polymeric nature and includes a repeating unit having the formula:

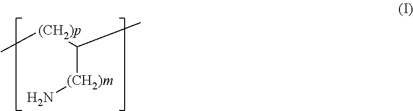

with m=0 or 1 or 2; p=1 or 2, or a salt thereof. The number of repeating units can be as discussed above.

In one embodiment, the molecular weight (MW) of the polyallylamine salt used in the present invention is in the range of 5000-150,000, such as 15000-70000 and more specifically 30000-50000 g/mol. As the skilled person will understand, the most suitable molecular weight of the ligands, i.e. the most suitable value of n, will depend on the substance to be separated, the properties of the insoluble support and other conditions. Polyallylamine is easily prepared by commonly known methods of polymerization or obtained from commercial sources.

In an advantageous embodiment, the ligand is immobilized via the amine group to a support. Methods of immobilizing ligands via amine groups are well known in this field, see e.g. Immobilized Affinity Ligand Techniques, Hermanson et al, Greg T. Hermanson, A. Krishna Mallia and Paul K. Smith, Academic Press, INC, 1992.

In one embodiment, the spacer (SP) starts at the base matrix and extends (a) to the nitrogen. The spacer may be any conventional spacer commonly used to attach ion exchange ligands and other ligands to insoluble supports. In one embodiment, it comprises a linear, branched, cyclic saturated, unsaturated and aromatic hydrocarbon group, such as a chain of 1-20, such as 1-10 carbon atoms. The spacer may be introduced according to conventional covalent coupling methodologies Illustrative coupling chemistries involve epichlorohydrin, epibromohydrin, allyl-glycidylether, bisepoxides such as butanedioldiglycidylether, halogen-substituted aliphatic substances such as di-chloro-propanol, divinyl sulfone, carbonyldiimidazole, aldehydes such as glutaric dialdehyde, quinones, cyanogen bromide, periodates such as sodium-meta periodate, carbodiimides, chloro-triazines, sulfonyl chlorides such as tosyl chlorides and tresyl chlorides, N-hydroxy succinimides, oxazolones, maleimides, 2-fluoro-1-methylpyridinium toluene-4-sulfonates, pyridyl disulfides and hydrazides.

The base matrix, i.e. the insoluble support to which the polyallylamine ligands according to the invention have been coupled, directly or indirectly via a spacer as discussed above, may be based on organic and/or inorganic material.

In an advantageous embodiment, the base matrix is hydrophilic and in the form of a polymer, which is insoluble and more or less swellable in water. Hydrophobic polymers that have been derivatized to become hydrophilic are included in this definition. Suitable polymers are polyhydroxy polymers, e.g. based on polysaccharides, such as agarose, dextran, cellulose, starch, pullulan, etc. and completely synthetic polymers, such as polyacrylic amide, polymethacrylic amide, poly(hydroxyalkylvinyl ethers), poly(hydroxyalkylacrylates) and polymethacrylates (e.g. polyglycidylmethacrylate), polyvinylalcohols and polymers based on styrenes and divinylbenzenes, and copolymers in which two or more of the monomers corresponding to the above-mentioned polymers are included. Polymers, which are soluble in water, may be derivatized to become insoluble, e.g. by cross-linking and by coupling to an insoluble body via adsorption or covalent binding. Hydrophilic groups can be introduced on hydrophobic polymers (e.g. on copolymers of monovinyl and divinylbenzenes) by polymerization of monomers exhibiting groups which can be converted to OH, or by hydrophilization of the final polymer, e.g. by adsorption of suitable compounds, such as hydrophilic polymers.

In an alternative embodiment, the base matrix is made from inorganic materials such as zirconium oxide, graphite, tantalum oxide, silica etc.

Preferred base matrices lack groups that are unstable against hydrolysis, such as silanes, esters, amide groups and groups present in silica as such. This in particular applies with respect to groups that are in direct contact with the liquids used.

The matrix may be porous or non-porous. This means that the matrix may be fully or partially permeable (porous) or completely impermeable to the substance to be removed (non-porous), i.e. the matrix should have a Kₐᵥ in the interval of 0.40-0.95 for substances to be removed. This does not exclude that Kₐᵥ may be lower, for instance down to 0.10 or even lower for certain matrices, for instance having extenders. See for instance WO 1998/033572 (GE Healthcare Bio-Sciences AB).

In an advantageous embodiment of the present invention, the base matrix is in the form of irregular or essentially spherical particles with sizes in the range of 1-1000 μm, preferably 5-50 μm for high performance applications and 50-300 μm for preparative purposes.

In other embodiments, the base matrix may be in the form of a membrane, monolith, chip or other surface. In a specific embodiment, the base matrix is magnetic, such as magnetic beads to which ligands according to the invention have been coupled.

In a specific embodiment, the base matrix has a density which is higher or lower than the liquid. This kind of matrices is especially applicable in large-scale operations for fluidised or expanded bed chromatography as well as for different batch wise procedures, e.g. in stirred tanks. Fluidised and expanded bed procedures are described in WO 1992/018237 (GE Healthcare Bio-Sciences AB) and WO 1992/000799 (Kem-En-Tek).

The term hydrophilic matrix means that the accessible surface of the matrix is hydrophilic in the sense that aqueous liquids are able to penetrate the matrix. Typically the accessible surfaces on a hydrophilic bass matrix expose a plurality of polar groups for instance comprising oxygen and/or nitrogen atoms. Examples of such polar groups are hydroxyl, amino, carboxy, ester, ether of lower alkyls.

The level of anion-exchange ligands in the anion-exchangers used in the invention is usually selected in the interval of ionic capacities between 0.01-2 mmol/ml matrix. Possible and preferred ranges are among others determined by the kind of matrix, ligand, and substance to be removed etc. Thus, the level of anion-exchange ligands is usually within the range of 0.1-1.5 mmol/ml matrix with preference for 0.2-0.9 mmol/ml matrix for agarose based matrices. The expression “mmol per ml matrix” refers to fully sedimented matrices saturated with water. The capacity range refers to the capacity of the matrix in fully protonated form to bind chloride ions.

In one embodiment, polyallylamine ligands are coupled in a not homogenous fashion in order to generate differences of ligand densities (ionic capacities) in different parts of the matrix.

In a specific embodiment, the polyallylamine ligands have been attached to the surface or outer part of the base matrix only, which embodiment has been presented as “lid beads” as ligands are present in a “lid” surrounding an inner part of the matrix. Such beads may be prepared e.g. as described in U.S. Pat. No. 6,426,315. In an advantageous embodiment, polyallylamine ligands as described herein constitute less than 50% of the total volume of the matrix. In a specific embodiment, the ligands constitute 1-30% of the total volume of the matrix.

The adsorption and/or desorption steps may be carried out as a chromatographic procedure with the anion-exchange matrix in a monolithic form or as particles in the form of a packed or a fluidized bed. For particulate matrices, these steps may be carried out in a batch-wise mode with the particles being more or less completely dispersed in the liquid, e.g. in a fluidized/expanded bed.

During adsorption, a liquid sample containing at least one negatively charged substance is contacted with the anion-exchanger defined above under conditions permitting adsorption (binding). In an advantageous embodiment, such binding takes place by charge-charge interaction between ligand and substance. In other words, the substance is at least partially negative and the ligand at least partially positive.

In a specific embodiment, weak anion-exchangers, such as anion exchangers comprising a primary or secondary amine group, are buffered to a pH within the interval pH≦pKa+2, preferably pH≦pKa+1. The lower limit can extend down to at least pH=1 or 2 and is primarily determined by the stability of the anion-exchanger in acidic milieu and by the isoelectric point (pI) and stability of the substance to be removed. The pKa-value of an anion-exchanger is taken as the pH at which 50% of its titratable groups are neutralized.

The ionic strength, which is measured as salt concentration or conductivity, is typically below the elution ionic strength for the particular combination of ion-exchanger, substance to be bound, temperature and pH, solvent composition etc. One of the benefits of the invention is that by using the mixed mode anion-exchangers defined above, it will be possible to carry out adsorption/binding also at elevated ionic strengths compared to what normally has been done for conventional ion-exchangers i.e. reference anion-exchangers. By matching the anion-exchanger with the substance to be removed, the adsorption may be carried out at an ionic strength that is higher than when using the reference ion-exchanger, measured at the same pH and otherwise the same conditions. Depending on the anion-exchanger used the ionic strength may be more than 25% higher such as more than 40% higher. Some combinations of anion-exchanger and substance to be removed may permit adsorption at more than 100% higher ionic strength than when using the corresponding reference ion-exchanger according to above.

In the adsorption buffer, the conductivity/ionic strength to be used will depend on the ligand used, its density on the matrix, the substance to be bound, its concentration etc.

Depending on the anion-exchanger selected, breakthrough capacities ≧200%, such as ≧300% or ≧500% and even ≧1000% of the breakthrough capacity obtained for a particular substance with the reference anion-exchanger may be accomplished (the same conditions as discussed before).

Desorption may be carried out according to well known protocols. Preferably the desorption process comprises at least one of the following procedures: (A) Increasing the salt concentration (ionic strength), (B) Increasing pH in order to lower the positive charge on the ligands, (C) Decreasing pH for decreasing a negative charge or for reversing the charge on the substance bound to the matrix, (D) Adding a ligand analogue or an agent (e.g. a solvent) that reduces the polarity of the adsorption buffer.

The conditions provided by (A)-(D) may be used in combination or alone. The most suitable choice will depend on the particular combination of (a) substance to be desorbed, (b) anion-exchanger (ligand, kind of matrix, spacer and ligand density), and (c) various variables of the desorption buffer, such as chemical composition, polarity, temperature, pH etc.

Replacing the adsorption buffer with desorption buffer thus means that at least one variable such as temperature, pH, polarity, ionic strength, content of soluble ligand analogue etc shall be changed while maintaining the other conditions unchanged so that desorption can take place.

In the simplest cases this means: (a) an increase in ionic strength and/or (b) a decrease in pH for reducing the negative charge of the substance to be desorbed, when changing from adsorption buffer to desorption buffer. Alternative (a) includes a decreased, a constant or an increased pH. Alternative (b) includes a decreased, an increased or a constant ionic strength.

In chromatographic and/or batch procedures the matrix with the substance to be desorbed is present in a column or other suitable vessel in contact with the adsorption buffer, which is commonly the aqueous liquid wherein the substance has been produced such as a fermentation broth having added buffer. The conditions provided by the liquid are then changed as described above until the desired substance is eluted from the matrix. After adsorption, a typical desorption process means that the ionic strength is increased compared to that used during adsorption and in many cases correspond to at least 0.4 M NaCl, such as at 0.6 M NaCl, if pH or any of the other variables except ionic strength are not changed. The actual values will depend on the various factors discussed above.

The change in conditions can be accomplished in one or more steps (step-wise gradient) or continuously (continuous gradient). The various variables of the liquid in contact with the matrix may be changed one by one or in combination.

Typical salts to be used for changing the ionic strength are selected among chlorides, phosphates, sulphates etc of alkali metals or ammonium ions.

Typical buffer components to be used for changing pH are preferably selected amongst acid-base pairs in which the buffering component can not bind to the ligand, i.e. piperazine, 1,3-diaminopropane, ethanolamine, Tris etc. A decrease in pH in step (ii) will reduce the negative charge of the substance to be desorbed, assist desorption and thus also reduce the ionic strength needed for release from the matrix. Depending on the pKa of the ligand used and the pI of the substance to be released, an increase in pH may result in the release of the substance or increase its binding to the ion-exchange matrix.

Desorption may also be assisted by adjusting the polarity of the desorption buffer to a value lower than the polarity of the adsorption buffer. This may be accomplished by including a water-miscible and/or less hydrophilic organic solvent in the desorption buffer. Examples of such solvents are acetone, methanol, ethanol, propanols, butanols, dimethylsulfoxide, dimethylformamide, acetonitrile, tetrahydrofuran etc. A decrease in polarity of aqueous desorption buffer (compared to the adsorption buffer) is likely to assist in desorption and thus also reduce the ionic strength needed for release of the substance from the matrix.

In a sub-aspect the present inventive method enables high recoveries of an adsorbed substance, for instance recoveries above 60% such as above 80% or above 90%. Recovery is the amount of the desorbed substance compared to the amount of the substance applied to an anion-exchanger in the adsorption/binding step. In many instances, the recovery can exceed even 95% or be essentially quantitative. Typically the amount of the substance applied to an anion-exchanger is in the interval of 10-80%, such as 20-60%, of the total binding capacity of the anion-exchanger for the substance.

The novel anion-exchangers according to the invention are likely useful in desalting, e.g. by enabling adsorption at high ionic strength and desorption at a lowered ionic strength by first changing the pH to reduce the positive charge of the adsorbed substance.

### EXAMPLES

The present examples are provided for illustrative purposes only, and should not be construed as limiting the invention as defined in the appended claims.

### 1. Synthesis of Anion-Exchangers

There are a variety of methods for immobilizing ligand-forming compounds to surfaces. We have described the methods we have adopted for preparing the new series of anion exchanger to serve as examples. As base matrix we have used SEPHAROSE™ 6 Fast Flow (GE Healthcare Bio-Sciences AB, Uppsala, Sweden), which will be referred to as SEPHAROSE™ 6FF throughout.

### A. Introduction of Allyl Groups on a Matrix:

SEPHAROSE™ 6FF (GE Healthcare Bio-Sciences, Uppsala, Sweden) and an agarose matrix prototype prepared according to U.S. Pat. No. 6,602,990 (herein denoted HFA MP) were activated with allylglycidyl ether as follows:

### 1. Introduction of Allyl Groups on SEPHAROSE™ 6FF

1a. Water was removed from SEPHAROSE™ 6 FF matrix (300 ml) by filtration until a weight of 226 g was reached. To the matrix was successively added a 50% aqueous solution of sodium hydroxide (150 ml), dist. water (2 ml), sodium borohydride (1.6 g) and sodium sulfate (36 g). The mixture was stirred for 1 hour at 50° C. Allyl glycidyl ether (300 ml) was then added and the suspension was stirred at 50° C. for an additional 19 hours. The mixture was filtered and the gel was washed successively on the filter with 6×300 mL distilled water, 5×300 ml ethanol, 5×300 ml distilled water, 3×300 ml 0.2 M acetic acid and finally 7×300 ml distilled water. Titration gave a degree of substitution of 0.366 mmol allyl/ml of gel.

1b. Water was removed from SEPHAROSE™ 6 FF matrix (250 ml) by filtration on a glass filter until a weight of 183 g was reached. To the matrix was successively added a 50% aqueous solution of sodium hydroxide (250 ml), dist. water (7.5 ml), sodium borohydride (1.4 g) and sodium sulfate (30.3 g). The mixture was stirred for 1 hour at 50° C. Allyl glycidyl ether (250 ml) was then added and the suspension was stirred at 50° C. for an additional 20 hours. The mixture was filtered and the gel was washed successively on the filter with 6×250 mL distilled water, 5×250 ml ethanol, 5×250 ml distilled water, 3×250 ml 0.2 M acetic acid and finally 10×250 ml distilled water. Titration gave a degree of substitution of 0.454 mmol allyl/ml of gel.

### 2. Introduction of Allyl Groups on HFA MP

To drained HFA MP matrix (100 ml) a 50% aqueous solution of sodium hydroxide (142 ml) was added. The mixture was stirred for 0.5 hour at 50° C. Allyl glycidyl ether (46 ml) was then added and the suspension was stirred at 50° C. for an additional 18 hours. The mixture was filtered and the gel was washed successively on the filter with 3×100 mL distilled water, 5×100 ml ethanol and finally 5×100 ml distilled water.

Titration gave a degree of substitution of 0.404 mmol allyl/ml of gel.

B. Activation of Matrixes with Bromine
General Procedure for Activation with Bromine

To the allyl containing matrix (A) in distilled water (1 ml/ml gel), sodium acetate trihydrate (approximately 0.2 g/mmol allyl groups) was added. To the mixture, a saturated aqueous bromine solution was added until a persistent yellow colour was obtained. Sodium formiate was then added until the suspension was fully decolorized. The reaction mixture was filtered and the gel was washed on the filter with 10× gel volume with distilled water. The activated gel was then directly reacted with the poly(allylamine) ligand.

### C. Immobilization of Ligand on the Activated Matrix

1. Immobilization of Poly(allylamine hydrochloride) MW 15,000 on Bromine Activated SEPHAROSE™ 6FF

### General Procedure (for the Reaction Details See Table Below):

To a solution of poly(allylamine hydrochloride) in dist. water, a 50% aqueous solution of sodium hydroxide was added to adjust the pH. The solution was added to the bromine activated SEPHAROSE™ 6FF matrix and the reaction was stirred for 20-21 hours at 50° C. The mixture was filtered and the gel was successively washed on the filter with 10× gel volume with distilled water, 1× gel volume with 0.5M HCL, 1× gel volume with 1 mM HCL and 2× gel volume with distilled water.

TABLE 1
Details for coupling of poly(allylamine hydrochloride)
MW 15,000 to SEPHAROSE ™ 6FF

| Starting | Starting gel | | Amount of | | Water | | Ionic capacity* |
|---|---|---|---|---|---|---|---|
| gel id. | amount | | amine | | (ml) | pH | .(μmol/ml) gel Id |
| Activated | 3.0 | g | 0.8 | g | 10 | 11.7 | 299 |
| 1a | (1.1 | mmol allyl) | (0.05 | mmol) | | | C1a |
| Activated | 3.0 | g | 2.3 | g | 10 | 11.5 | 460 |
| 1b | (1.4 | mmol allyl) | (0.15 | mmol) | | | C1b |
| Activated | 2.5 | g | 1.7 | g | 1.5 | 13.7 | 614 |
| 1b | (1.1 | mmol allyl) | (0.11 | mmol) | | | C1c |

*The ionic capacity was determined by titration of the coupled gel.

2. Immobilization of Poly(allylamine hydrochloride) MW 70,000 on Bromine Activated SEPHAROSE™ 6FF

### General Procedure (for Reaction Details See Table Below):

To a solution of poly(allylamine hydrochloride) in dist. water, a 50% aqueous solution of sodium hydroxide was added to adjust the pH. The solution was added to the bromine activated SEPHAROSE™ 6FF matrix and the reaction was stirred for 20 hours at 50° C. The mixture was filtered and the gel was washed successively with 10× gel volume distilled water, 1× gel volume with 0.5M HCL, 1× gel volume with 1 mM HCL and 2× gel volume with distilled water.

TABLE 2
Details for coupling of poly(allylamine hydrochloride)
MW 70 000 to SEPHAROSE ™ 6FF

| Starting | Starting gel | | Amount of | | Water | | Ionic capacity* |
|---|---|---|---|---|---|---|---|
| gel id. | amount | | amine | | (ml) | pH | .μmol/ml) gel Id |
| Activated | 3.0 | g | 0.5 | g | 10 | 12.5 | 278 |
| 1b | (1.4 | mmol allyl) | (0.007 | mmol) | | | C2a |
| Activated | 3.0 | g | 1.0 | g | 10 | 12.4 | 379 |
| 1b | (1.4 | mmol allyl) | (0.015 | mmol) | | | C2b |
| Activated | 2.5 | g | 1.6 | g | 4 | 13.0 | 669 |
| 1b | (1.1 | mmol allyl) | (0.024 | mmol) | | | C2c |

*The ionic capacity was determined by titration of the coupled gel.

3. Immobilization of poly(allylamine hydrochloride) MW 15,000 on Bromine Activated HFA MP (C3)

To a solution of poly(allylamine hydrochloride) (1.8 g, 0.12 mmol) in dist. water (3 ml), a 50% aqueous solution of sodium hydroxide was added to adjust the pH to 12.9. The mixture was added to the bromine activated HFA MP matrix (3.0 g, 1.2 mmol) and the reaction was stirred for 17 hours at 50° C. The mixture was filtered and the gel was washed successively on the filter with 10× gel volume distilled water, 1× gel volume with 0.5M HCL, 1× gel volume with 1 mM HCL and 2× gel volume with distilled water.

The ionic capacity, corresponding to the amount of amines, was determined by titration to be 466 μmol/mL gel.

4. Immobilization of poly(allylamine hydrochloride) MW 70,000 on Bromine Activated HFA MP (C4)

To a solution of poly(allylamine hydrochloride) (0.9 g, 0.013 mmol) in dist. water (4 ml), a 50% aqueous solution of sodium hydroxide was added to adjust the pH to 13.7. The mixture was added to the bromine activated HFA MP matrix (2.5 g, 1.0 mmol) and the reaction was stirred for 17 hours at 50° C. The mixture was filtered and the gel was washed successively on the filter with 10× gel volume distilled water, 1× gel volume with 0.5M HCL, 1× gel volume with 1 mM HCL and 2× gel volume with distilled water to be 416 μmol amine/ml gel.

### Chromatographic Results

The prototypes ability to capture proteins at different salt concentrations, using buffers spanning from low to high conductivity, was tested with BSA as model protein. Breakthrough capacities (Qb_{10%}) tests were run on an ÄKTA™ Explorer 100 (GE Healthcare Bio-Sciences AB, Uppsala, Sweden).

The prototypes were packed in 1 ml HR5/5 columns. The sample solution was BSA (4 mg/ml) dissolved in buffer (20 mM piperazine, Sodium chloride solution, pH set to 6.0 with hydrochloric acid). The capacity was determined at four different salt concentrations, i.e. the concentration of sodium chloride being 0 M, 0.5 M, 0.25 M or 0.4 M. After equilibration of the columns with the buffer, the solution of BSA in buffer was pumped through the HR5/5 columns containing the prototypes at a flow rate of 1 ml/min. The breakthrough capacity at 10% of absorbance maximum (Q_{b10%}) was calculated according to the formula:

Q_{b10%}=(T_{R10%}−T_{RD})×C/V_{c}

where T_{R}10% is the retention time (min) at 10% of absorbance maximum, T_{RD} the void volume time in the system (min), C the concentration of the sample (4 mg protein/ml) and V_{C} the column volume (ml).

### Results

The results obtained for breakthrough capacities for a series of representative “high salt” anion-exchanger ligands are summarized in table 3. The results indicate that the new anion-exchange ligands have much higher breakthrough capacity (Qb_{10%}) for BSA compared to Q SEPHAROSE™ Fast flow.

TABLE 3
Capacity (Qb_{10%}) results for poly(allylamine) prototypes

| | Capacity (Qb_{10%}) of BSA (mg/ml) | | | |
|---|---|---|---|---|
| | at varied salt concentrations | | | |
| Gel id. | 0M NaCl | 0.15M NaCl | 0.25M NaCl | 0.4M NaCl |
| C1a | 7 | 39 | 56 | 45 |
| C1b | 15 | 79 | 81 | 78 |
| C1c | 18 | 85 | 99 | 91 |
| C2a | 5 | 25 | 48 | 48 |
| C2b | 9 | 60 | 76 | 75 |
| C2c | 19 | 124 | 136 | 128 |
| C3 | n.d | n.d | 94 | n.d |
| C4 | n.d | n.d | 107 | n.d |
| Ref. | 69 | n.d | 1 | n.d |

n.d = not determined
Ref. = Q SEPHAROSE ™ 6FF with an IC of 240 μmol/ml gel.

It is apparent that many modifications and variations of the invention as hereinabove set forth may be made without departing from the spirit and scope thereof. The specific embodiments described are given by way of example only, and the invention is limited only by the terms of the appended claims.

1. A method for removing at least one negatively charged substance from an aqueous liquid by contacting the liquid with a separation matrix comprising a plurality of polyallylamine ligands, comprising binding said negatively charged substance to said ligands under conditions where the ionic strength of the aqueous liquid applied to the chromatography resin ≧0.25 M NaCl.

2. The method of claim 1, wherein the ligands are polymeric and comprise a repeating unit having the formula: 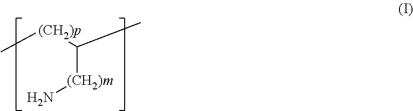
with m=0 or 1 or 2; p=1 or 2; or any salt thereof.

3. The method of claim 2, wherein the polymeric ligands comprise 5-2500 repeating units of the formula (I).

4. A method for removing at least one negatively charged substance from an aqueous liquid by contacting the liquid with a separation matrix comprising a plurality of ligands wherein the ligands are polymeric and have the formula: 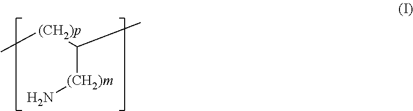
with m=0 or 1 or 2; p=1 or 2; or any salt thereof,
under conditions permitting binding of said substance to said separation matrix, followed by a subsequent desorption of said substance, wherein said separation matrix has been selected to be capable of binding said substance in a aqueous liquid at an ionic strength ≧0.25 M NaCl.

5. The method of claim 4, wherein the polymeric ligands comprise 5-3000 repeating units of the formula (I).

6. The method of claim 4, wherein the substance is desorbed from the matrix by applying an aqueous liquid having a pH which is different from the pH of aqueous liquid applied to adsorb the substance in order to decrease or eliminate the negative charge of the substance.

7. The method of claim 4, wherein the substance is desorbed from the matrix by applying an aqueous liquid having an ionic strength ≧0.3 M NaCl.

8. The method of claim 1, wherein the negatively charged substance is adsorbed to a level corresponding to an adsorption of at least 40 mg, preferably 80 mg or most advantageous of 130 mg of BSA/ml separation matrix.

9. The method of claim 1, wherein the adsorbed substance is a protein which is adsorbed to a level of at least 40 mg, preferably 80 mg or most advantageous of 130 mg of substance/ml separation matrix.

10. The method of claim 1, wherein the substance is a protein or a peptide.

11. The method of claim 10, wherein the substance is an antibody; an antibody fragment or a fusion protein comprising an antibody.

12. The method of claim 1, wherein the substance is removed by flowthrough chromatography.

13. The method of claim 1, wherein the substance has a molecular weight of less than 100 kDa.

14. At least one chromatography ligand which is polymeric and include a repeating unit having the formula: 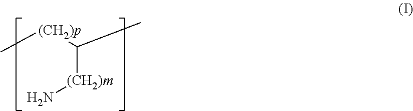
with m=0 or 1 or 2; p=1 or 2; or any salt thereof.

15. The ligand of claim 14, which is polymeric and includes 5-3000 repeating units of the formula (I).

16. A separation matrix comprising the ligands of claim 14 coupled to an insoluble support.

17. The separation matrix of claim 16, wherein the support comprises particles such as substantially spherical particles.

18. The separation matrix of claim 16, wherein the support comprises a membranous structure.

19. The separation matrix of claim 16, wherein the insoluble support is agarose, preferably crosslinked agarose.

20. The separation matrix of claim 16, wherein magnetic particles are incorporated in the support.

21. The separation matrix of claim 16, wherein the ligands have been coupled to the support in a non-homogenous fashion.

22. The separation matrix of claim 16, wherein the ligands are immobilized in less than 50% of the total volume of the matrix.

23. A chromatography column packed with the separation matrix of claim 16.

24. The method of claim 4, wherein the negatively charged substance is adsorbed to a level corresponding to an adsorption of at least 40 mg, preferably 80 mg or most advantageous of 130 mg of BSA/ml separation matrix.

25. The method of claim 4, wherein the adsorbed substance is a protein which is adsorbed to a level of at least 40 mg, preferably 80 mg or most advantageous of 130 mg of substance/ml separation matrix.

26. The method of claim 4, wherein the substance is a protein or a peptide.

27. The method of claim 4, wherein the substance is an antibody; an antibody fragment or a fusion protein comprising an antibody.

28. The method of claim 4, wherein the substance is removed by flowthrough chromatography.

29. The method of claim 4, wherein the substance has a molecular weight of less than 100 kDa.
